(19) United States
(12) Patent Application Publication
(10) Pub. No.: US 2008/0044516 A1
(43) Pub. Date: Feb. 21, 2008

(54) Granules of Hydrophilic Active Principle

(76) Inventors: Jean-Marie Dollat, Montlucon (FR); Veronique Chiavazza, Caluire (FR)

Correspondence Address: OLIFF & BERRIDGE, PLC, P.O. BOX 320850, ALEXANDRIA, VA, 22320-4850, US

(21) Appl. No.: 11/667,445

(22) PCT Filed: Dec. 14, 2005
(86) PCT No.: PCT/FR05/03132

§ 371 Date: Jun. 21, 2007

(30) Foreign Application Priority Data
Dec. 15, 2004 (FR) 0413346

(51) Int. Cl. A23K 1/00; A23J 3/00; A23P 1/08; A23P 1/12

(52) U.S. Cl. 426/2; 426/656; 426/96

(57) ABSTRACT

The present invention relates to cores of granules of hydrophilic active principle, characterized in that they also comprise starch or a derivative thereof. The present invention also relates to hydrophilic active principle granules intended for the nutrition or treatment of ruminants.

The present invention relates to cores of granules of hydrophilic amino acid. The present invention also relates to granules of hydrophilic amino acid intended for ruminant nutrition or treatment.

Certain compounds, for example vitamins, mineral salts and amino acids, are essential in the diet of ruminants since they are limiting in the daily nutritional intake. The diet of ruminants is thus generally supplemented with these compounds.

When they are administered orally to ruminants, these compounds are destroyed in the rumen via the action of the digestive enzymes. Thus, in order to be beneficial to and assimilable by the animals, these compounds are protected with a coating that allows them to pass through the rumen without damage and to be broken down in the abomasum, so as to release the active principle in the intestine.

It is known practice to prepare granules suitable for administration to ruminants and these granules are generally composed of a core of active principle and a coating that is resistant to the neutral pH of the rumen and degradable at the more acidic pH of the abomasum.

One of the possibilities for preparing active principle cores consists in performing a melt-extrusion. The extrusion machines are machines that use both heat and pressure, by forcing the mixture to be extruded through a die. During this step, the active principles undergo an irreversible degradation.

To solve this problem, patent FR 2 663 818 proposes the use of a meltable binder. In this respect, use is generally made of a fatty substance, for example stearic acid. These fatty substances have the advantage of mixing readily with hydrophobic active principles.

However, when it is a matter of mixing a hydrophilic active principle, present in high content in the mix, with one of the known meltable binders, homogenization difficulties are encountered.

The present invention seeks to allow the easy extrusion of hydrophilic active principles.

The inventors have realized, surprisingly, that by adding a compound chosen from starches to the known meltable binders, this objective is achieved.

The present invention thus relates to granule cores intended for animal nutrition, the said granule cores comprising:

a hydrophilic amino acid present in an active content of greater than or equal to 60% by weight of the granule core,

at least one meltable binder,

at least one plasticizer,

characterized in that the said cores also comprise a compound chosen from starches.

Document EP 1 405 570 describes a feed additive for ruminants, comprising a lysine magnesium phosphate. However, the additive described in this document has a lysine content not exceeding 43% by weight in the finished product.

Patent application WO 02/10208 relates to a process for preparing an amino acid by fermentation. The amino acid thus obtained is then processed into a form.

Patent U.S. Pat. No. 5,279,832 relates to a preparation of active substance, especially amino acid, for oral administration. This document does not describe a composition allowing the easy extrusion of hydrophilic amino acids present in high content in the composition.

The inventors also advantageously realized that the active principle cores of the present invention, and also the granules comprising these said cores, have many advantages that will be presented throughout the description hereinbelow.

The hydrophilic amino acids have established physiological activity in the animal. They are especially included in the category of feed supplements. Animal feed supplements are products intended to be ingested, as a supplement to the common diet, in order to overcome the insufficiency of the daily intake of certain compounds. It is known practice, for example, in general, to supplement the feed rations of reared animals with amino acids, so as to increase the zootechnical performance of the reared animals.

Advantageously, the amino acid is chosen from the group consisting of lysine, arginine and tyrosine, and salts and esters thereof. As a guide, the hydrophilic amino acid is L-lysine or its commercial form: L-lysine hydrochloride. It may also be L-arginine hydrochloride or L-tyrosine hydrochloride.

The hydrophilic amino acid is also present in an active content of greater than or equal to 60% by weight of the granule core. Advantageously, the hydrophilic amino acid is present in an active content of greater than or equal to 64% by weight of the granule core.

The term “active content” means the real content of amino acid itself, i.e. the amino acid in the base form having the physiological activity in the animal whose effect is sought. It may be the form that is fully assimilated by the animal's body. The reason for this is that the amino acids may be in a commercial form that is more advantageous and easier to handle than the active form. This is especially the case when the amino acid is in the form of a salt or analogue. It results therefrom that, if it is decided to use a commercial form of the amino acid that is different from the amino acid itself, a person skilled in the art must calculate the weight equivalence, the real active content of amino acid. This active content may represent, for example, a certain percentage of the content of active form, belonging to the starting compound mixture.

It is also important to point out that, in the context of the present invention, the contents are expressed as weight percentages of the granule core or, depending on the case, as weight percentages of the granule itself.

The granule core also comprises at least one meltable binder. The meltable binder is selected from the group consisting of polyethylene glycol waxes, paraffins, oils or fats, fatty acids containing from 10 to 32 carbon atoms, esters and the corresponding alcohols, and the corresponding di- and triesters. As a guide, it may especially be stearic acid. Mention may also be made of Precirol® and Compritol®.

The granule cores according to the present invention also comprise at least one plasticizer. This plasticizer is preferentially chosen from cellulose or its derivatives, and especially ethylcellulose.

The cores of the granules of the present invention are characterized in that they comprise a starch. The term “starch” means any polysaccharide formed from the combination of two polymers: amylose and amylopectin. According to the present invention, the starch may be in powder form or in paste form. As a guide, it may be native wheat starch, native corn starch, native rice starch or potato starch. It may also be the same starches treated physically, for example pregelatinized.

A disintegrant that accelerates the breakdown of the tablet in the digestive tract may also be added to the granule cores. This disintegrant may especially be talc, silica, carbonate or polyphosphate, for example Na₂O, CaO, P₂O₅ or Al₂O₃.

The cores may also comprise another active principle or several other active principles, in addition to the hydrophilic amino acid present in an active content of greater than or equal to 60% by weight.

The term “other active principle” means any substance having an established physiological activity in the animal. Especially included in the category of active principle according to the invention are feed supplements. Animal feed supplements are products intended to be ingested, as a supplement to the common diet, in order to overcome the insufficiency of the daily intake of certain compounds. It is known practice, for example, in general, to supplement the feed rations of reared animals with active principles, so as to increase the zootechnical performance of the reared animals. These may especially be vitamins, mineral salts, amino acids, trace elements, hormones or antibiotics.

Advantageously, the said other active principle is an amino acid. As a guide, mention may be made of methionine, tryptophan or 2-hydroxy-4-methylthiobutanoic acid (hydroxy analogue of methionine), which has the advantage of being in liquid form, which facilitates its use by the feed-producing companies. Mention may also be made of the salts and esters of these compounds.

The said other active principle is preferentially present in a very low active content, of less than or equal to 1% by weight of the granule core.

Advantageously the present invention also relates to a granule core in which the active principles, i.e. the hydrophilic amino acid and possibly at least one other active principle, are present in an active content of greater than 64% by weight of the granule core.

According to another embodiment of the present invention, the hydrophilic amino acid is present in an active content of greater than or equal to 64% by weight of the granule core.

The granule cores are conventionally obtained via a melt extrusion process. This process is fully described in patent FR 2 663 818.

The ingredients are first mixed together and then blended.

It is possible, according to the present invention, for the process for preparing the granule cores to comprise a preliminary step of dry co-grinding of the ingredients prior to extrusion, the said co-grinding being preferably performed at a temperature of not more than 50° C.

The term “grinding” more particularly means the mechanical action that consists in reducing the starting ingredients to a given size. The term “co-grinding” implies the grinding of several ingredients at the same time. The co-grinding is thus performed “dry”, i.e. all the ingredients are in dry form, usually in powder form. To perform the co-grinding according to the present invention, it is not necessary to add a liquid ingredient to the mixture, or to dissolve one or all of the ingredients. The co-grinding of the ingredients requires the use of a mill, which may be chosen especially from knife mills, rotor mills, bar mills, grate mills, disc mills or ball mills. The choice of mill depends mainly on the expected particle size distribution of the ground product.

It is also possible, according to the present invention, to add water to the mixture after co-grinding and before extrusion. As a guide, less than 10% of water by weight of the mixture before extrusion is added. Preferably, between 3% and 5% of water by weight of the mixture before extrusion is added. Thus, the granule cores obtained after the process may also contain a certain amount of water.

The mass to be extruded is then forced through an extruder, preferably a single-screw or twin-screw extruder, equipped with one or more dies having orifices of the desired granule diameter.

The advantageous composition of the granule cores according to the present invention allows a better extrusion rate or “extrudability” (see examples).

After extrusion, the rods undergo a spheronization step, the object of which is to make the rods perfectly spherical, without irregularities or surface roughness (as smooth as possible).

It is also important to point out that the quality of the coating step that follows, and thus of the protection of the active principle, lies mainly in the spheronization step.

In a subsequent step, the spheronized granule cores are coated so as to obtain protected granules.

The present invention also relates to a hydrophilic amino acid granule that comprises:
a core as defined above, and
a coating protecting the active principle(s) against degradation in the rumen of ruminants.

It is also important to point out that, in the context of the present invention, the contents are expressed as weight percentages of the granule core or, depending on the case, as weight percentages of the granule itself. On account of the presence of the coating, this percentage differs from the weight percentage of the granule core and a person skilled in the art must then calculate this new percentage.

In the case of a hydrophilic amino acid present in an active content of greater than or equal to 60% by weight of the granule core and in the situation of a coating representing 15% by weight of the granule, the hydrophilic active principle is present, as equivalent in the granule itself, at an active content of greater than or equal to 51% by weight of the granule.

The present invention advantageously covers an active content of hydrophilic amino acid of greater than or equal to 64% by weight of the granule core, or, in the same situation as previously (i.e. a coating representing 15% by weight of the granule), in an active content of greater than 54.4% by weight of the granule.

Also, the said other active principle is preferentially present in a very low active content, of less than or equal to 1% by weight of the granule core.

In the situation of a coating representing 15% by weight of the granule, the said other active principle is present, as equivalent, at an active content of less than or equal to 0.85% by weight of the granule itself.

The coating step proceeds in accordance with the teaching described in patents EP 462 015 and EP 447 298, via a composition based on a pH-sensitive polymer. This composition has many advantages and in particular it is not degraded in the rumen, but may be released in the abomasum and/or the intestine.

The coating process comprises a first step of polymerization of monomers in aqueous emulsion, a second step of preparation of the coating emulsion and a third step of deposition of the said aqueous emulsion onto the active principle cores.

As a guide, the pH-sensitive polymers, which are prepared by aqueous-emulsion polymerization, are chosen from:
polyvinyl acetals of acetylacetic esters substituted with dialkyl nitrogen groups such as the diethylamino group,
copolymers of styrene or of acetonitrile with vinylpyridine isomers or derivatives, and
chitosan salts.

The copolymer based on styrene and on 2-vinylpyridine is preferably used.

The polymer is prepared by placing the monomer(s) in contact with a surfactant and a polymerization initiator.

The surfactants are preferably chosen from the alkaline salts of fatty acids, for example the sodium salt of oleic acid and the sodium salt of stearic acid.

The polymerization initiator is chosen from the soluble initiators conventionally used in emulsion processes, for example sodium persulfate. The pH during the polymerization is preferably set at between 10 and 14.

Once the aqueous emulsion has been performed, the coating emulsion is prepared. An aqueous emulsion containing the pH-sensitive polymer obtained in the preceding step, and a hydrophobic substance, are preferably used as coating composition.

The hydrophobic substance is especially chosen from fatty acids containing 12 to 22 carbon atoms, esters thereof (especially mono-, di- and triesters) and salts thereof. It may especially be stearic acid.

The aqueous emulsion may also contain additives such as antistatic agents, fungicides, plasticizers, dyes, appetent agents, for example, olfactory additives, and additional emulsifiers.

The emulsion is then deposited onto the cores to be coated. For example, this emulsion is sprayed onto the active principle granules.

The quality of the extrudates is evaluated by means of a friability test. The friability test is performed, on a Sotax Friabilitor USP F1 machine, with 10 g of extrudates for 5 minutes at 50 rpm. The friability is given by the following formula: (initial weight—weight of rods recovered after the test)/initial weight.

The granules of hydrophilic active principle of the present invention have many advantages. Among these, and as is shown on reading the examples that follow, are especially degrees of protection and degrees of release with respect to granules not advantageously containing starch or derivatives.

The conditions of the tests performed to determine the degrees of protection and release of the active principles in the granules of the present invention are as follows:
Degree of release (in vitro test)

This is represented by the percentage fraction of the active principle dissolved from the protected form, after a residence time of 2 hours with stirring in an aqueous medium maintained at pH 2 (potassium sulfate and 2N sulfuric acid to permanently maintain the pH at 2) and 40° C., under standardized conditions.

As a guide, the degree of release of granules containing methionine is measured under these conditions by iodimetry, whereas that of lysine is measured by argentometry. In general, HPLC or any other chromatographic method (especially ion exchange) is used.
Degree of protection (in vitro test)

This is represented by the percentage fraction of the amino acid not released from the protected form, after a residence time of 24 hours with stirring in a buffer solution at pH 6.0 (phosphoric acid/dipotassium phosphate) and 40° C., under standardized conditions.

As a guide, the degree of protection of granules containing methionine is measured under these conditions by iodimetry, whereas that of lysine is measured by argentometry. In general, HPLC or any other chromatographic method (especially ion exchange) is used. The degree of protection is deduced therefrom by difference (difference between the amount of active principle introduced and the amount of active principle released).

The appearance of the granules, more particularly their size and their shape, is very important.

The choice of the size of the granules depends directly on the zootechnical application. It is generally imposed by physiological reasons, for example to avoid the process of remastication by the ruminants.

The spheronized granule cores should be round, spherical and free of roughness (as smooth as possible), such that the coating step proceeds under the best conditions, and such that the active principle is correctly and uniformly protected.

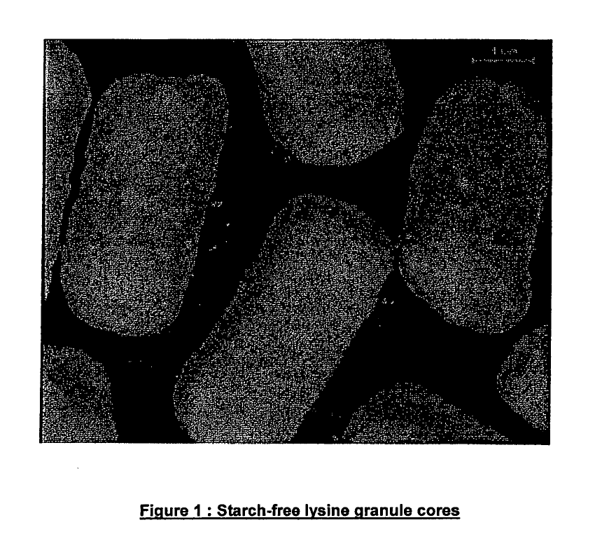

FIGS. 1 to 4 are photographs of granule cores and granules:

FIG. 1 shows starch-free lysine granule cores;

compared with FIG. 1,

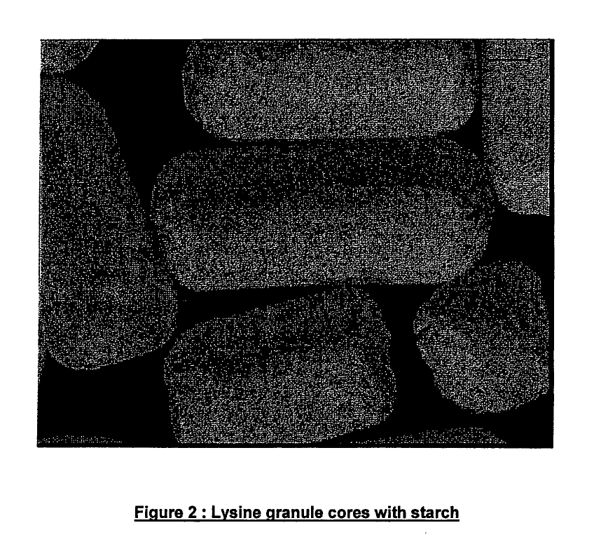

FIG. 2 shows lysine granule cores with starch, as obtained according to the present invention;

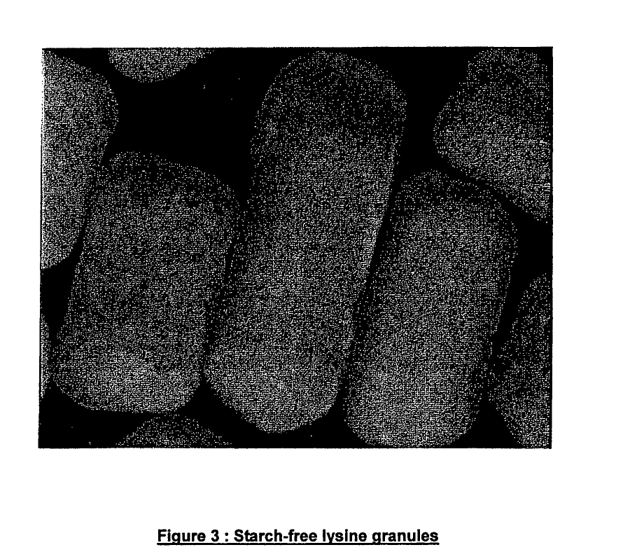

FIG. 3 shows starch-free lysine granules;

comparatively,

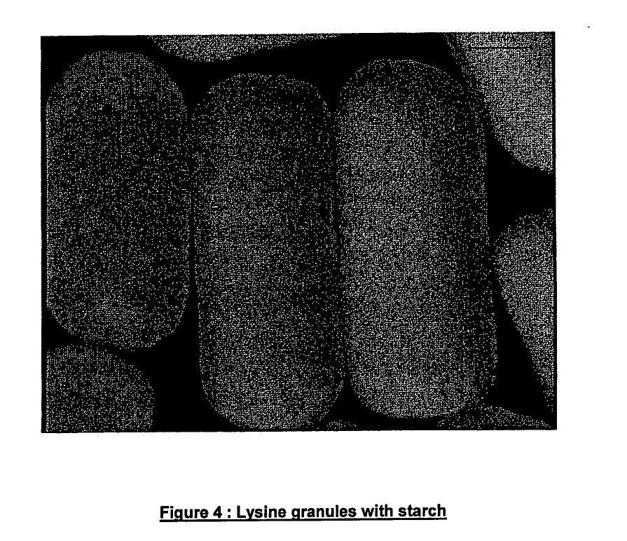

FIG. 4 shows lysine granules with starch, as obtained according to the present invention.

The particle size distribution of the granules is also an important industrial characteristic. Advantageously, the granules of the present invention have a diameter of 1 to 3 mm and a length of 1 to 5 mm.

The examples and tables below will enable some of the advantages and characteristics of the present invention to be demonstrated.

### EXAMPLE 1

### Lysine Granules without Starch

The equipment used to prepare the starch-free lysine granule cores and granules is as follows:
a Böhle mixer with a rotating cylindroconical tank, model LM 40;
a Retsch laboratory grate mill;
a Bivis Haake Rheomex TW 100 extruder configured with two counter-rotating screws (diameter 19.7 mm and length 331 mm) and a nine-hole die (2 mm in diameter);
a “Wyss-Probst engineering” spheronizer (300×100 mm tank) with circulation of thermostatically-maintained oil in the jacket; and
a UniGlatt mini fluid bed (2 L tank equipped with a “Würster” nozzle).

The friability test is performed on a Sotax friabilator USP F1 with 10 g of extrudates, for 5 minutes at 50 rpm.

The operating conditions are as follows:

800 g of lysine hydrochloride, 180 g of stearic acid and 20 g of ethylcellulose are introduced into the tank of the Böhle mixer, and mixed together for 15 minutes at 50 rpm.

This mixture is then ground on a 1 mm grate at speed 1.

The particle size of the mixture leaving the laboratory grinder is such that a powder is obtained with 50% of particles <50 μm and less than 10% of particles >200 μm.

On leaving the mill, the mixture obtained is rehomogenized using the Böhle mixer for 15 minutes, still at 50 rpm.

This mixture is introduced via a hopper into the Bivis extruder, the temperatures in the three sections of which have been preset to:
72° C. in the feed compartment;
78° C. in the intermediate compartment; and
80° C. in the compartment before the die.

The extrusion rate is about 1 kg/h.

The extrudates obtained are chopped to a length of 2 mm. They are then characterized in terms of friability.

The friability of the extrudates is measured: it is between 1.5 and 2%.

The extrudates are then spheronized at 500 rpm, for 8 minutes and at 90° C., and are then screened between 1.4 and 2.5 mm. The yield of this operation is 87%.

The screened extrudates are then coated using the emulsion prepared by stirring with a polytron blender at a temperature of between 75 and 90° C.

The emulsion, with a solids content of 25%, has the following composition:
stearic acid: 20%
copolymer of 2-vinylpyridine and of styrene at 20% solids: 24.96%
water: 55%
solid sodium hydroxide: 0.04%
   The spraying rate is 10 g/min and the yield is 98%.

After deposition of the coating agent, the extrudates are characterized in terms of degree of protection and degree of release of lysine.

For a degree of coating of 14.6%, the content of base lysine is 54.2%, the degree of protection measured in vitro ranges between 61% and 89%, and the degree of release is 95%.

| % Degree of | % Content of | % Degree of | % Degree of |
|---|---|---|---|
| coating | base lysine | protection in vitro | release |
| 14.6 | 54.2 | 61 to 89 | 95 |

### EXAMPLE 2

### Lysine Granules with Cornstarch

Example 1 is repeated with the same apparatus, but replacing some of the stearic acid with standard native cornstarch.

800 g of lysine hydrochloride, 120 g of stearic acid, 60 g of standard cornstarch and 20 g of ethylcellulose are thus mixed together.

The mixture is co-ground in a manner identical to that of Example 1.

The particle size distribution of the mixture leaving the laboratory mill is such that a powder is obtained with 50% of particles <50 μm and less than 10% of particles >200 μm.

The stearic acid assay (average of 13 measurements) gives 11.8% for a theoretical value of 12%.

The mixture is then extruded under the following conditions:
72° C. in the feed compartment;
75° C. in the intermediate compartment; and
78° C. in the compartment before the die.

The extrusion rate is about 2 kg/h. The extrusion rate is thus far better than that of Example 1, in which starch is not used. By developing an identical torque, by means of the advantageous use of cornstarch, the extrusion rate is doubled. It may thus be envisaged to double the production efficiency by using starch. This is an advantage of the present invention.

The extrudates obtained are chopped to a length of 2 mm and then characterized in terms of friability.

The friability of the extrudates is measured: it is between 0.5% and 0.8%.

The friability of the extrudates comprising lysine and starch is better than that of the extrudates comprising lysine alone (Example 1), which is a guarantee of quality of the extrudates obtained.

The extrudates are then spheronized at 500 rpm, for 6 minutes and at 90° C., and then screened between 1.4 and 2.5 mm. The yield for this operation is 88%.

Two degrees of coating, of 15% and 16%, respectively, were performed on this batch of extrudates. The spraying rate is 10 g/min and the yields are 98% and 97%.

The product quality results are collated in the table below.

| % Degree of | % Content of | % Degree of | % Degree of |
|---|---|---|---|
| coating | base lysine | protection in vitro | release |
| 14.6 | 56 | 96 | 100 |
| 16.4 | 55.2 | 99 | 100 |

By comparison with Example 1, for an equivalent degree of coating (14.6% of the weight of the granule), the lysine granules with cornstarch have a degree of protection of 96%, which is largely superior to that of the starch-free granules (61% to 89%). With a higher degree of coating (16.4% of the weight of the granule), the degree of protection of the lysine granules with starch rises to 99%.

Additionally, the granules with starch have a degree of release of 100%, as opposed to 95% for the starch-free lysine cores.

### EXAMPLE 3

### Lysine Granules with Wheat Starch

Example 2 is repeated with the same apparatus, but replacing the cornstarch with wheat starch.

800 g of lysine hydrochloride, 120 g of stearic acid, 60 g of wheat starch and 20 g of ethylcellulose are thus mixed together.

The mixture is co-ground under the same conditions as those of Example 2 and extruded under the following conditions:
72° C. in the feed compartment;
75° C. in the intermediate compartment; and
78° C. in the compartment before the die.

The extrusion rate is about 1.4 kg/h. The extrusion rate is therefore better than that of Example 1, in which starch is not used.

The extrudates obtained are chopped to a length of 2 mm and then characterized in terms of friability.

The friability of the extrudates is between 0.6% and 1%.

The extrudates are then spheronized at 500 rpm for 7 minutes and at 90° C., and then screened between 1.4 and 2.5 mm. The yield for this operation is 85%.

As regards the coating, the spraying rate is 10 g/min and the yield is 98%.

For a degree of coating of 14.6%, the base lysine content is 56.2%, the degree of protection measured in vitro is 88% and the degree of release is 100%.

| % Degree of | % Content of | % Degree of | % Degree of |
|---|---|---|---|
| coating | base lysine | protection in vitro | release |
| 14.6 | 56.2 | 88 | 100 |

### EXAMPLE 4

### Lysine Granules with Potato Starch

Example 2 is repeated with the same apparatus, but replacing the cornstarch with potato starch.

800 g of lysine hydrochloride, 120 g of stearic acid, 60 g of potato starch and 20 g of ethylcellulose are thus mixed together.

The mixture is co-ground under the same conditions as those of Example 2 and extruded under the following conditions:
73° C. in the feed compartment;
75° C. in the intermediate compartment; and
79° C. in the compartment before the die.

The extrusion rate is about 1.5 kg/h. The extrusion rate is also better than that of Example 1, in which starch is not used.

The extrudates obtained are chopped to a length of 2 mm and then characterized in terms of friability.

The friability of the extrudates is between 0.5% and 0.7%.

The extrudates are then spheronized at 500 rpm for 6 minutes and at 90° C., and then screened between 1.4 and 2.5 mm. The yield for this operation is 89%.

As regards the coating, the spraying rate is 10 g/min and the yield is 99%.

For a degree of coating of 14.6%, the base lysine content is 56.2%, the degree of protection measured in vitro is 96% and the degree of release is 100%.

| % Degree of | % Content of | % Degree of | % Degree of |
|---|---|---|---|
| coating | base lysine | protection in vitro | release |
| 14.6 | 56.2 | 96 | 100 |

### EXAMPLE 5

### Lysine Granules with Arbocel Cellulose

Example 2 is repeated with the same apparatus, but replacing the cornstarch with Arbocel cellulose.

800 g of lysine hydrochloride, 120 g of stearic acid, 60 g of Arbocel cellulose and 20 g of ethylcellulose are thus mixed together.

The mixture is co-ground under the same conditions as those of Example 2 and extruded under the following conditions:
73° C. in the feed compartment;
75° C. in the intermediate compartment; and
75° C. in the compartment before the die.

The extrusion rate is about 0.5 kg/h. The extrusion rate is lower than that of Example 1, starch not being used either. The advantageous property of starch or derivatives thereof on the extrusion rate is not reproduced here.

The extrudates obtained are chopped to a length of 2 mm and then characterized in terms of friability.

The friability of the extrudates is between 1.5% and 2%. It is thus higher than that of the extrudates comprising starch (Examples 2, 3 and 4).

The extrudates are then spheronized at 500 rpm for 6 minutes and at 90° C., and then screened between 1.4 and 2.5 mm. The yield for this operation is 88%.

As regards the coating, the spraying rate is 10 g/min and the yield is 98%.

For a degree of coating of 16.4%, the base lysine content is 53.4%, the degree of protection measured in vitro is 89% and the degree of release is 100%.

| % Degree of | % Content of | % Degree of | % Degree of |
|---|---|---|---|
| coating | base lysine | protection in vitro | release |
| 16.4 | 53.4 | 89 | 100 |

### EXAMPLE 6

### Lysine and Methionine Granules with Cornstarch

Example 2 is repeated with the same apparatus, but incorporating 0.35% of methionine at the expense of the stearic acid.

800 g of lysine hydrochloride, 3.5 g of methionine, 116.5 g of stearic acid, 60 g of cornstarch and 20 g of ethylcellulose are thus mixed together. The mixture is co-ground under the same conditions as those of Example 2 and extruded under the following conditions:
72° C. in the feed compartment;
75° C. in the intermediate compartment; and
78° C. in the compartment before the die.

The extrusion rate is about 1.6 kg/h.

The extrudates obtained are chopped to a length of 2 mm and then characterized in terms of friability.

The friability of the extrudates is between 0.4% and 0.6%.

Their apparent density is between 0.62 and 0.64 g/cm³.

The true density calculated for the granules is 1.24 g/cm³.

The extrudates are then spheronized at 500 rpm for 8 minutes and at 90° C., and then screened between 1.4 and 2.5 mm. The yield for this operation is 92%.

As regards the coating, the spraying rate is 11 g/min and the yield is 96%.

For a degree of coating of 15%, the base lysine content is 55%, the degree of protection measured in vitro is 96% and the degree of release is 100%.

| % Degree of | % Content of | % Degree of | % Degree of |
|---|---|---|---|
| coating | base lysine | protection in vitro | release |
| 15 | 55 | 96 | 100 |

### EXAMPLE 7

### Lysine and Methionine Granules with Cornstarch

The equipment used is as follows:
a 3000 litre industrial band mixer;
a Contraplex industrial disc mill;
a Clextral industrial twin-screw extruder, model Evolum 53 with 2 co-rotating screws (L/D=24), 6 sleeves set at 60, 80, 80, 80, 70 and 70° C. of feed to the die, a straight die with two times 6 holes (length 12 mm, diameter 2 mm, L/D=6) and a 4-blade knife;
a Caleva 700 spheronizer; and
a fluidized-bed tank of 300 litres equipped with 5 nozzles in top-spray configuration.

The extrudates are thus prepared, spheronized and coated using industrial equipment.

The friability test is performed on a Sotax friabilator USP F1 performed with 10 g of extrudates for 5 minutes at 50 rpm.

The operating conditions are as follows:

1025 kg of mixture containing 80% lysine hydrochloride, 0.35% methionine, 11.65% stearic acid, 6% cornstarch and 2% ethylcellulose are co-ground.

The particle size distribution of the mixture leaving the mill is such that a powder is obtained with 60% of particles having a diameter of less than 50 μm and 5% of particles having a diameter of greater than 200 μm.

The stearic acid assayed in the mixture is 12.07% (for a theoretical value of 11.65%).

This mixture serves to feed an industrial extruder operating at 60 kg/hour (screw speed 200 rpm) and at a chopping speed of 1800 rpm. Simultaneously, a flow of water may advantageously be added to the compartment upstream of the extruder. For example, this flow may be between 5% and 10% of the mixture (i.e. 3 to 6 kg/h for an extrusion rate of 60 kg/h).

The extrusion yield, defined as the % of extrudates longer than 1.4 mm, is 99%.

The friability measured for these extrudates is between 0.5 and 0.7%.

Their apparent density is 0.62 g/cm³ and their true, calculated density is 1.24 g/cm³.

After extrusion, the extrudates are spheronized in 25 kg batches. The industrial machine 700 mm in diameter is set at 350 rpm for an extrudate temperature of 90° C. The spheronization time is 12 min. The extrusion yield, defined as the percentage of granules between 1.4 and 2.5 mm, is 83%.

The spheronized granules are then coated under the following conditions:
Amount of charged spheronized granules: 150 kg
Amount of sprayed coating:
   116.4 kg of 25% solids
   i.e. 29.1 kg solids
Real spraying rate: 45 kg/h
Amount of granules obtained: 178.8 kg
Theoretical amount expected: 179.1 kg
Real degree of coating:
   16.2%
   i.e. 3.2% of copo V2P/styrene
Material balance: 99.8%

For a degree of coating of 16%, the base lysine content is 51.2%, the degree of protection measured in vitro is 94% and the degree of release is 98%.

| % Degree of | % Content of | % Degree of | % Degree of |
|---|---|---|---|
| coating | base lysine | protection in vitro | release |
| 16 | 51.2 | 94 | 98 |

TABLE 1
Summary table of the compositions of the granule cores

| Component | | Example 1 | Example 2 | Example 3 | Example 4 | Example 5 | Example 6 | Example 7 |
|---|---|---|---|---|---|---|---|---|
| Lysine | g | 800 | 800 | 800 | 800 | 800 | 800 | |
| | % HCl | 80 | 80 | 80 | 80 | 80 | 80 | 80 |
| | % Base | 64 | 64 | 64 | 64 | 64 | 64 | 64 |
| Methionine | g | Abs. | Abs. | Abs. | Abs. | Abs. | 3.5 | |
| | % | | | | | | 0.35 | 0.35 |
| Stearic acid | g | 180 | 120 | 120 | 120 | 120 | 116.5 | |
| | % | 18 | 12 | 12 | 12 | 12 | 11.65 | 11.65 |
| Starch | type | Abs. | corn | wheat | potato | Abs. | corn | corn |
| (or equivalent) | | | | | starch | | | |
| | g | | 60 | 60 | 60 | | 60 | |
| | % | | 6 | 6 | 6 | | 6 | 6 |
| Other | type | | | | | Arbocel | | |
| | | | | | | cellulose | | |
| | g | | | | | 60 | | |
| | % | | | | | 6 | | |
| Ethylcellulose | g | 20 | 20 | 20 | 20 | 20 | 20 | |
| | % | 2 | 2 | 2 | 2 | 2 | 2 | 2 |
| Total weight | g | 1000 | 1000 | 1000 | 1000 | 1000 | 1000 | |
| | or kg | | | | | | | 1025 |

Abs. = Absent

TABLE 2
Summary table of the characteristics of the granule cores and granules

| | | Example 1 | Example 2 | | Example 3 | Example 4 | Example 5 | Example 6 | Example 7 |
|---|---|---|---|---|---|---|---|---|---|
| Starch | Type | Abs. | Corn | | Wheat | Potato | Abs. | Corn | Corn |
| | | | | | | starch | | | |
| Lysine content in | % HCl | 80 | 80 | | 80 | 80 | 80 | 80 | 80 |
| the cores | | | | | | | | | |
| | % Base | 64 | 64 | | 64 | 64 | 64 | 64 | |
| Extrusion rate | kg/h | 1 | 2 | | 1.4 | 1.5 | 0.5 | 1.6 | 60 |
| Friability of the | % | 1.5-2 | 0.5-0.8 | | 0.6-1 | 0.5-0.7 | 1.5-2 | 0.4-0.6 | 0.5-0.7 |
| extrudates | | | | | | | | | |
| Degree of coating | % by | 14.6 | 14.6 | 16.4 | 14.6 | 14.6 | 16.4 | 15 | 16 |
| | weight of | | | | | | | | |
| | the granule | | | | | | | | |
| Lysine content in | % Base | 54.2 | 56 | 55.2 | 56.2 | 56.2 | 53.4 | 55 | 51.2 |
| the granules | | | | | | | | | |
| Degree of | % | 61-89 | 96 | 99 | 88 | 96 | 89 | 96 | 94 |
| protection in vitro | | | | | | | | | |
| Degree of release | % | 95 | 100 | 100 | 100 | 100 | 100 | 100 | 98 |

Abs. = Absent

1. Granule core intended for animal feed, comprising:
a hydrophilic amino acid present in an active content of greater than or equal to 60% by weight of the granule core,
at least one meltable binder,
at least one plasticizer,
characterized in that it also comprises at least one starch.

2. Core according to claim 1, in which the hydrophilic amino acid is selected from the group consisting of lysine, arginine and tyrosine, and salts and esters thereof.

3. Core according to claim 1, comprising another active principle.

4. Core according to claim 3, in which the said other active principle is chosen from the group consisting of methionine and 2-hydroxy-4-methylthiobutyric acid.

5. Core according to claim 3, in which the said other active principle is present in an active content of less than or equal to 1% by weight of the granule core.

6. Core according to claim 1, in which the active principles are present in an active content of greater than 64% by weight of the granule core.

7. Core according to claim 6, in which the hydrophilic amino acid is present in an active content of greater than or equal to 64% by weight of the granule core.

8. Core according to claim 1, in which the meltable binder is selected from the group consisting of polyethylene glycol waxes, paraffins, oils or fats, saturated or unsaturated fatty acids containing from 10 to 32 carbon atoms, the corresponding esters and alcohols and the corresponding diesters and triesters.

9. Core according to claim 1, in which the meltable binder is stearic acid.

10. Core according to claim 1, in which the plasticizer is selected from the group consisting of cellulose and its derivatives.

11. Hydrophilic amino acid granule intended for animal feed, comprising:
a core according to claim 1, and
a coating protecting the hydrophilic amino acid against degradation in the rumen of ruminants.

12. Process for preparing granule cores or granules according to claim 1, by extrusion, the said process comprising the following steps:
the ingredients are mixed together,
the mass to be extruded is forced through an extruder, preferably a single-screw or twin-screw extruder, equipped with one or more dies, so as to obtain rods,
the rods thus obtained are spheronized, and
the granule cores thus obtained are optionally coated, so as to obtain granules.

13. Process according to claim 12, wherein the preliminary co-grinding of the ingredients is performed before mixing them together.

14. Use of the granules according to claim 11 for feeding reared animals.
